(19) United States
(12) Patent Application Publication
(10) Pub. No.: US 2005/0044388 A1
(43) Pub. Date: Feb. 24, 2005

(54) Reprise encryption system for digital data

(76) Inventors: Gary E. Brant, Staten Island, NY (US); Ayanna M. Howard, Altadena, CA (US)

Correspondence Address: Patricia E. McQueeney;Becker & Poliakoff, P.A., 3111 Stirling Road, Fort Lauderdale, FL, 33312, US

(21) Appl. No.: 10/686,203

(22) Filed: Oct. 15, 2003

Related U.S. Application Data
(60) Provisional application No. 60/496,363, filed on Aug. 19, 2003.

(51) Int. Cl. H04L 9/00

(52) U.S. Cl. 713/186

(57) ABSTRACT

The reprise encryption system (RES) offers a unique method for securing digital entertainment files, including full-length movies, music recordings, video games, electronic books, and other electronic publications, so that these materials are protected in transit. RES can also be utilized in the healthcare field to ensure secure transmission of electronic medical records.

### CROSS-REFERENCE TO RELATED APPLICATIONS

This application claims priority under 35 USC § 119(e) to U.S. provisional patent application No. 60/496,363, currently pending.

### BACKGROUND OF THE INVENTION

(1) Field of the Invention

The Reprise Encryption System for Digital Data (“RES” or “the present invention”) relates to the field of digital cryptography and security of digital media, wherein the cryptographic system uses a private key derived from a biometric feature.

(2) Description of Related Art

There are several encryption technologies available in the marketplace. One widely known and implemented encryption tool is called the Public Key Infrastructure (PKI). PKI gets its name from its use of a class of cryptographic algorithms called a public key algorithm. As is widely known to those versed in the cryptographic field, a public key algorithm is a cryptographic algorithm that operates using two different but mathematically related keys. As the two keys are related but different, this technology is called an asymmetric key system. PKI recipients use unique public keys and private keys, which must be kept secret. Data encrypted with the public key may only be decrypted with the private key. PKI standards are well known, X.509 for example, described in Housley, R., “Internet X.509 Public Key Infrastructure Certificate and CRL Profile,” RFC 2459, January 1999, and ITU-T Recommendation X.509 (1997 E): Information Technology—Open System Interconnection—The Directory: Authentication Framework, June 1997.

Unfortunately, the widely utilized PKI key system suffers from several drawbacks. Users of the PKI key system have to manage and maintain multiple keys. This results in consumer confusion as to which key encrypts and which key decrypts and other issues. Usually, the private key is stored on their personal computer in a folder and is accessed by password. The maintenance of multiple keys and multiple passwords is too difficult for the average consumer. The present invention does not require a consumer to memorize a password and is therefore easier to operate.

Another drawback to the PKI key system and similar encryption technologies is the requirement that one key be transmitted with the encrypted file. This results in added size to the transmitted file, occasionally rendering the encrypted file too large for transmission. Present encryption technologies available on the marketplace have encryption key lengths of about 1024 bits. The key utilized in the present invention has an encryption length of 21,000 bits. Transmittal of the key of the present invention with the encrypted file would result in extreme time delay using today's transmittal technology, including broadband.

Finally, although developed to make interception more difficult for cyber thieves, the PKI technology is as susceptible to decrypting as prior technologies. This is because one key is transmitted with the encrypted file. A cyber thief only needs to locate the second key to crack the encryption. This is more alarming with the current rise in biometric encryption. If a cyber thief intercepts your biometric key, do you get a finger replacement? In other words, if a fingerprint scan comprised the second key in a PKI system, and the scan was intercepted by a cyber thief, would it be necessary to obtain a finger transplant to be able to obtain access to the system? Applicants have not seen this issue addressed in a satisfactory manner.

There are several systems currently available for on-line fingerprint verification and on-line signature verification. A secure method for accessing files using fingerprints has been is described in U.S. Pat. No. 6,122,737 to Bjorn et al. entitled METHOD FOR USING FINGERPRINTS TO DISTRIBUTE INFORMATION OVER A NETWORK. Similar to the present invention, fingerprint data is used to provide access to digital information, including software programs, sound or recorded music files, photographs, movies and the like. However, unlike the present invention, the user's actual fingerprint data is electronically transmitted each time the user requests access to encrypted information available via Bjorn et al's invention. This may result in the interception and fraudulent use of user's personal information.

Similarly, in U.S. patent application Pub. No. 20030101349 to Wang entitled METHOD OF USING CRYPTOGRAPHY WITH BIOMETRIC VERIFICATION ON SECURITY AUTHENTICATION, the biometric information is encrypted and transmitted. In addition, Wang's invention utilizes common encryption engines, DES and RSA, to perform encryption. A skilled hacker would have little difficulty in cracking these well known codes.

Another encryption technology currently available on the marketplace is called the private, or secret key system. This system utilizes a single key for both encryption and decryption. This technology is called a symmetric key system because only one key is used to encrypt and decrypt the digital file. This system is commonly quoted as outdated because it is supposedly easy to break and does not ensure secure transmissions. Once the private key is intercepted, a cyber thief can obtain access to the encrypted files. Conventional private key systems known in the art include Data Encryption Standard (DES) and International Data Encryption Algorithm (IDEA).

Unlike the above systems, the present invention, known as the Reprise Encryption System (RES) technology, combines the best of both worlds. A single key uniquely attributable to a consumer is used to encrypt and decrypt the digital file. However, RES is unique because biometric information itself is not the key. Yet, the key will not unlock the encrypted file without live, real-time confirmation of the biometric information of the intended recipient. Without providing the unique biometric confirmation at time of access, the encrypted files cannot be decrypted. If the key is intercepted, the thief is unable to use it because the key itself requires positive identification of the intended recipient. If the key is intercepted, a consumer can be provided a new key without obtaining a new finger, voice or iris. The key of the present invention has all the advantages associated with being a private key while simultaneously having none of its weaknesses, and being freely distributable and publishable.

In addition to the limitations discussed above, current encryption technology further suffers from the limitations in the encryption protocol. Encryption using every bit of data is not currently routine on large files because of limitations in computer processing abilities. Many encryption protocols currently encrypt blocks of bits rather than individual bits. For obvious reasons, this method is not as secure as utilizing each bit of data in the encryption protocol.

The current PKI (Public Key Infrastructure) technology is complex and requires multiple entities and systems to both administer and ensure integrity in the system. These protocols are unnecessarily difficult for the average user to understand, much less to use routinely. The steps involved including registering with a Certificate Authority (“C.A.”), purchasing of a Digital Certificate, which combines the user's public key information with a Certificate issued by the C.A. after the user provides proof of their identity to the C.A., embedding the Digital Certificate into the user's email and browser applications resident on a single computer (they may not be shared among multiple computers), and the creation of a key-entry password which must be remembered by the user in order to use their Digital Certificate. The Digital Certificate that is issued has a life cycle as applied by the Certificate Authority, at the end of the cycle the user has to purchase an extension or another new certificate. If any one of these steps is not carried out exactly, the user may not receive a functioning Digital Certificate or worse; may lock themselves out of their own computers if the password is forgotten or compromised by a cyber thief. An expired Digital Certificate would also render the user's critical data and files useless because they require an active Certificate and password to be accessed.

The present invention provides a radically simple methodology for creating a single symmetric encryption key, which can then be freely distributed for the purposes of encrypting data that needs to be secured. There is no Certificate Authority, there are no Digital Certificates to be issued, maintained, and managed, there are no time limitations applied to the life of the encryption key, there are no passwords to remember, because the consumer's live fingerprint is all that is required to access the encryption key, and it is impossible for the consumer's key to be accessed by anyone but the consumer, thereby protecting all of the consumer's critical data at the highest possible level.

Reprise Encryption System (RES) technology is unique because each and every bit of audio and video data is encrypted, not just the “header” or signature lines of the file to be protected. Therefore, the data so protected is virtually impossible to decrypt, or unlock.

### BRIEF SUMMARY OF THE INVENTION

As often occurs with advancing technology, the simple solutions are often overlooked. The present invention combines the simplicity of the private key system with the advances of technology so that encryption proceeds more easily and securely. The present invention, the reprise encryption system (RES) is a unique technology solution that provides effective copyright protection and/or security protection to digital data, including movies, video, audio, music, images, text, electronic documents, video games, software applications, financial data, medical information and any other digital data that a consumer wishes to protect during transmission. Parties to a transaction can use the present invention in contractual negotiations to ensure that the parties are who they represent to be. Transmission can take place via local or wide-area computer networks, wireless networks, wireless telephone networks, wireless data networks, and even via compact or digital video disks (CDs or DVDs).

The Reprise Encryption System (RES) offers a unique method for securing digital entertainment files, including full-length movies, music recordings, video games, electronic books, and other electronic publications, so that these materials are protected in transit. RES can also be utilized in the healthcare field to ensure secure transmission of electronic medical records. It can be used in support of Homeland Security to secure the vital information of military and government agencies during local, state or national emergencies.

RES is a complete, stand-alone system that secures digital data by virtue of a 21,000 bit symmetric encryption key. The encryption key is activated by a consumer's fingerprint scan performed by the RES fingerprint reading device. Unlike prior encryption technology, RES encrypts each and every byte of data, including every single frame of video and every single bit of audio data.

### BRIEF DESCRIPTION OF THE SEVERAL VIEWS OF THE DRAWINGS

FIG. 1 provides a schematic diagram one embodiment of the present invention.

FIG. 2 provides a schematic diagram of a second embodiment of the present invention.

### DETAILED DESCRIPTION OF THE INVENTION

As used throughout the specification and claims, the terms “biometrics” or “biometric features” mean any human characteristic that has the following properties: universality—every person should have the characteristic uniqueness—no two persons should possess the same characteristic permanence—the characteristic should not significantly change with time—it should be possible to measure the characteristic in a quantitative manner.

Biometric features that have been commonly used in developing automatic authentication systems include fingerprints, voice, iris, retina patterns, and face. Also, there are some other more unconventional biometrics such as body odors, gait, ear shape, etc. that have been used for developing methods for personal identification. All of these features are included within the scope of the present invention.

As used throughout the specification and claims, the term “key” means a cryptographic file structure that is used to encrypt or decrypt text.

As used throughout the specification and claims, the term “text” means any form of digital file. As the field of cryptography began with the ancient Greeks and written code, the definitions of encrypt and decrypt include the term “text.” However, the technology can be and is frequently applied to digital technology.

As used throughout the specification and claims, the terms “encryption” or “encrypt” mean the process of converting digital information from plain text to ciphered text.

As used throughout the specification and claims, the terms “decryption” or “decrypt” mean the process of converting digital information from ciphered text to plain text.

As used throughout the specification and claims, the terms “transmit” or “transmission” mean the transfer of information from one location to another. Transmission can take place using electronic or physical technology. For example, a compact disk or digital video disk transmitted via U.S. postal service mail is included as an embodiment of the present invention.

As used throughout the specification and claims, the term “archive” refers to a database in which text is stored. An archive can store any combination of video recordings, audio recordings, application software, medical records, electronic publications, military information, government records, financial information and video game software applications.

As used throughout the specification and claims, the term “decryption limitations” refers to the agreed conditions for which the text may be opened. For example, the archive owner may wish to limit access to digital text. The archive owner could program the encrypted text so that decryption is only available a limited number of times or for a limited time period. One embodiment of the use of decryption limitations is directed to audio files. A consumer would have the option of purchasing unlimited decryption or limited decryption, such as three months decryption ability. The archive owner could price the purchase accordingly.

As used throughout the specification and claims, the term “text reader” refers to any medium capable of decrypting the text file to plain text. This medium currently includes computers, portable digital assistants, digital video disc readers, compact disc readers and some cellular telephones, to name a few.

As used throughout the specification and claims, the term “plain” refers to a file or data being “open” or readable on a computer monitor, video screen or music playing device.

As used throughout the specification and claims, the term “portable” means easily carried or conveyed by hand.

The advent of the computer has been the downfall of the copyright industry. Once controlled through purchase of records and tapes, the computer allows easy access and sharing of many forms of intellectual property, including copyrighted books, music, video games and movies. The Recording Industry Association of America (RIAA) estimates that the recording industry experiences a forty percent (40%) loss of revenue on a yearly basis due to computer piracy.

The encryption technologies utilized to date with the movie and music CDs and DVDs have proven ineffective. In fact, the industry standard DVD encryption technology from Macrovision Corporation has been entirely defeated by computer programs that allow consumers to make perfect copies of commercial DVDs. The present invention allows the entertainment industry to securely transmit a single movie or song to a consumer via the internet. It also provides a unique method for encrypting and delivering content to customers on a three-inch DVD-ROM disk.

The encryption technology of the present invention allows the entertainment industry to prohibit duplication, file-sharing and other forms of copying and illegal sale. If desired, the entertainment industry can further offer music and/or video files that self-destruct after a certain time period at a lower “rental” rate. In addition, each and every copy of released music, video games, or movie content can be delivered on the three-inch DVD-ROM disk that can only be played back by the customer for whom the disk and its contents were manufactured. This means that all copies of the original studio content or copyright materials are completely protected from piracy.

The present invention can also be utilized in situations that require confidentiality, such as medical information or top-secret government information. Confidential information can be encrypted with keys to limited individuals. The encrypted information can be tracked, indicating who accessed the information and when. Unauthorized disclosure would be limited.

Another industry that would benefit from the technology of the present invention is the financial industry. Currently, some banking institutions require fingerprint impressions from non-account holders who wish to cash checks at that institutions. The present invention permits consumers to positively identify themselves to the banking institution without the mess of ink pads and paper. Further, the RES technology protects the customer's privacy and ensures that the fingerprint impression cannot be duplicated to steal the customer's identity.

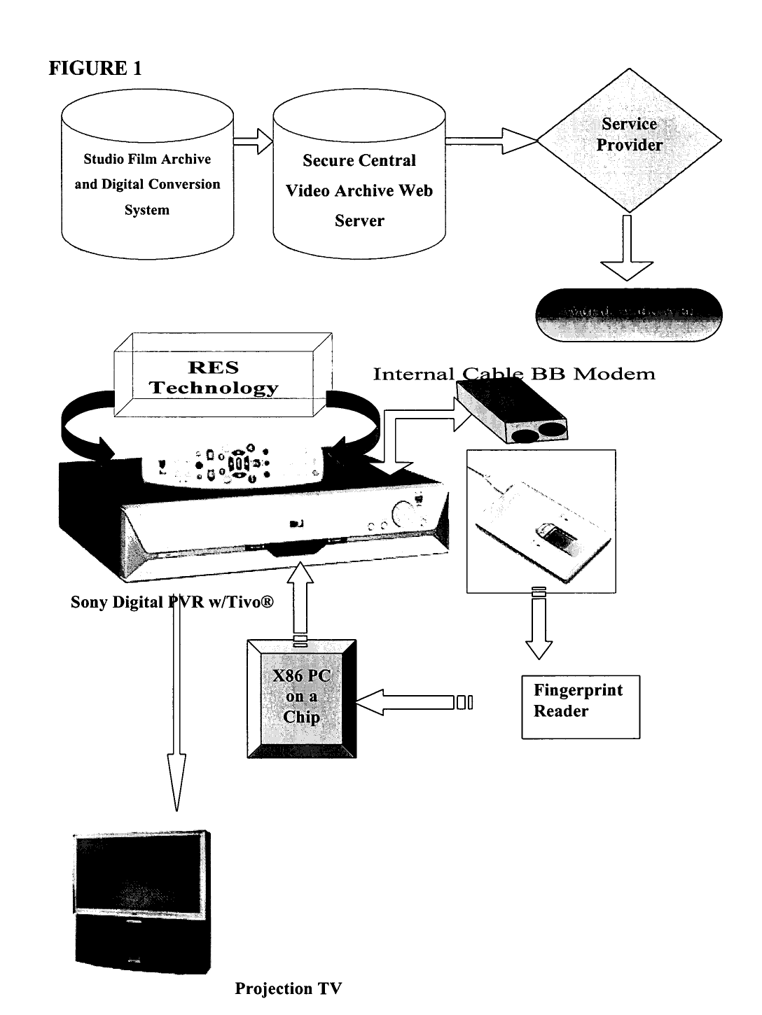

FIG. 1 provides a schematic diagram one embodiment of the present invention. This embodiment addresses on-line transmittal of copyrighted works, such as films, video games or movies. However, the present invention is not limited to this embodiment. One of ordinary skill in the art would recognize that the present invention also has application to the medical records industry as well as other industries that require security and positive identification.

As depicted in FIG. 1, a studio film archive and digital conversion system are converged for the purpose of securing the precious camera original or edited content. The digital conversion system of the present invention is novel in and of itself. The digital conversion system of the present invention takes each and every byte of digital information from the film or movie selected, including every single frame of video and every single bit of audio data, and places all of those bytes into “a container.” When a consumer requests a film or movie, the digital conversion system encrypts each and every byte of the film or movie selected with the 21,000 bit encryption key unique to the consumer. However, instead of performing this encryption function one time, the present invention performs the encryption function seven times. The encrypted file is unrecognizable, equivalent to thousands of ingredients placed in a very large blender and processed seven times. Furthermore, to break the encryption, a cyber thief would have to determine the seven variations of the file using a 21,000 bit key and reverse engineer the core algorithm used by the encryption system. To do so would be mathematically and technically impossible using today's technology. The conversion algorithm of the present invention performs this encryption in approximately two to three minutes for the average ninety-minute film. In addition, the conversion algorithm can be used to limit decryption of the film, video game or movie in several different ways; unlimited viewing, limited viewing, limited time duration, to name a few.

More importantly due to electronic transmission limitations currently experienced, the size of the film, video game or movie encrypted is the same before and after the encryption takes place. The encryption method of the present invention does not add to the size of the encrypted matter.

As depicted in FIG. 1, the consumer chooses the film, video game or movie via the world wide web from their projection television set. The service provider, upon receipt of the order, encrypts the selected movie, video game or film with the consumer's unique key, to prepare it for delivery to the consumer. Upon receipt of the film, videogame or movie, the consumer scans their fingerprint using the fingerprint reader to obtain permission to decrypt and view the delivered film, videogame or movie. Their fingerprint information is not transmitted over the internet, but maintained in the privacy of their home. The key contains absolutely no biometric data or other information that could be used by a hacker to recreate the consumer's biometric information. This feature protects the consumer's privacy and ensures that “identity theft” cannot take place.

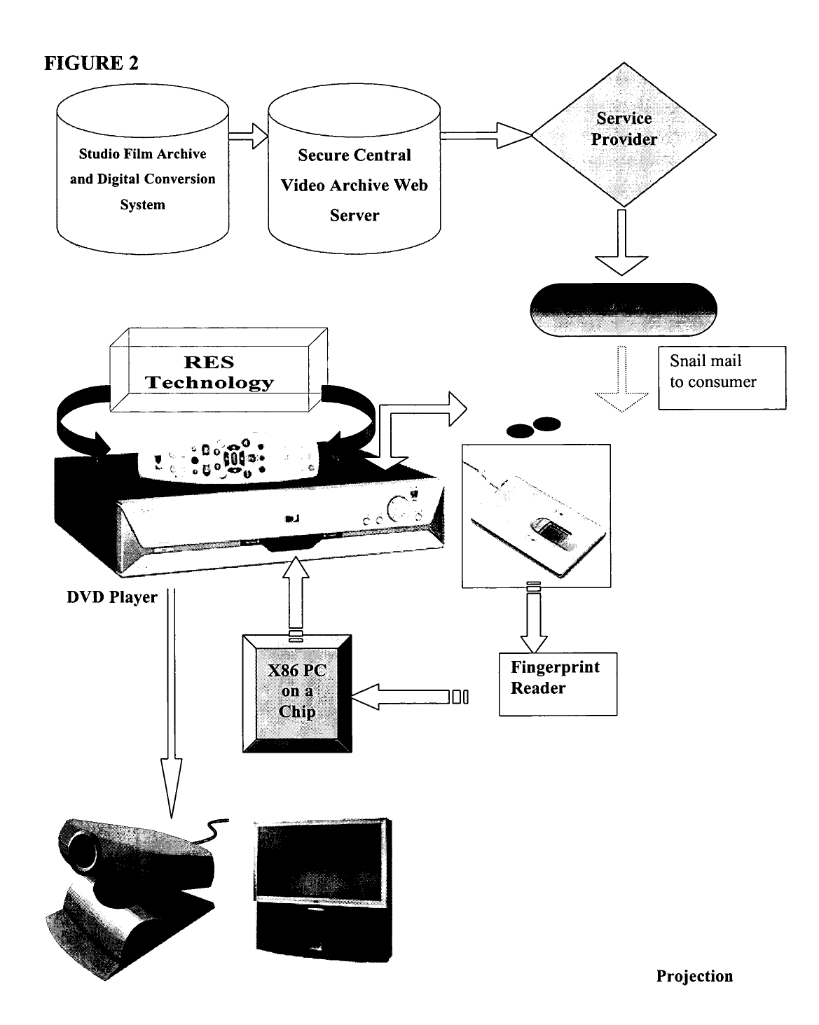

FIG. 2 provides a schematic diagram of a second embodiment of the present invention. This embodiment addresses transmittal of copyrighted works, such as films, music, video games or movies. However, the present invention is not limited to this embodiment. One of ordinary skill in the art would recognize that the present invention also has application to the medical records industry as well as other industries that require security and positive identification.

Many consumers of movies and music do not have access to computers. The second embodiment of the present invention addresses this limitation. Some consumers may prefer this embodiment even when they have computer access. The consumer chooses one or more films, songs, video games or movies via e-mail or snail mail request to the service provider. The service provider, upon receipt of the order, encrypts the selected movies, songs, video games or films with the consumer's unique key, to prepare it for delivery to the consumer. The service provider can encrypt the film, video game, music or movie in several different ways; unlimited viewing, limited viewing, limited time duration, to name a few. The service provider places the encrypted selections upon a three-inch digital video disk (DVD-ROM) and transmits the disk to the consumer. The three-inch digital video disk provided for exemplary purposes and is not intended to limit the scope of the present invention. One of ordinary skill in the art would recognize that any form of digital storage medium could be utilized with the present invention.

Upon receipt of the disk, the consumer scans their fingerprint using the fingerprint reader to obtain permission to decrypt and view the delivered films, songs, video games or movies. Their fingerprint information is not transmitted, but maintained in the privacy of their home. The key contains absolutely no biometric data or other information that could be used by a hacker to recreate the consumer's biometric information. This feature protects the consumer's privacy and ensures that “identity theft” cannot take place.

### EXAMPLES

The following examples are provided for exemplary purposes only and should not be regarded as limiting the scope of the appended claims.

### Example 1

One embodiment of the present invention addresses piracy issues associated with digital music and videos.

In the present embodiment, a customer registers to use the Video Delivery System via the provider's home page on the internet. The provider issues the customer a fingerprint sensor for enrollment. The customer downloads the required computer application from the provider's web site. The customer then utilizes the computer application to generate their unique encryption key. The encryption key is forwarded by e-mail to the provider. At this point, the customer has completed enrollment process.

The customer once again visits the provider's web site and selects the desired movie, video game or music. The customer places their finger on the fingerprint sensor and “signs” their order request. The provider now has absolute confirmation that this message request came from this customer because the message is signed with the customer's fingerprint data. The selected music or movie is encrypted with the customer's unique encryption key and sent to the customer via broadband internet connection.

Upon receipt of the encrypted music or movie, the customer places their finger on the fingerprint sensor, thereby releasing or unlocking the encryption technology. The customer is now able to play the music or view the movie.

### Example 2

Another common piracy issue arises at the recording studios. Copies of master tapes are pirated to outside sources, resulting in lost profits for the artist and producer. The present invention can be used to encrypt the master disk so that limited people have access to it. With this technology, even if the master disk is “accidentally” misplaced, no piracy results as only people with access can play it.

### Example 3

Example 3 provides a third embodiment of the present invention. This embodiment addresses use of the technology of the present invention during a medical emergency. However, the present invention is not limited to this embodiment. One of ordinary skill in the art would recognize that the present invention also has application to other medical uses as well as other industries that require security and positive identification.

In the embodiment depicted in Example 3, a consumer's medical information is contained on a portable card. RES is used to encrypt the medical information contained on the card. During a medical emergency, instead of proceeding through paperwork and wasting valuable emergency response time, a consumer provides the card to hospital personnel. Hospital personnel verify that the consumer is the same person as indicated on the card and decrypt the medical information contained thereon using real time verification of the patient's biometric information. If the card is lost, no medical information is revealed because the key needed to unlock the encrypted file contained on the card can only be accessed through real time confirmation of the consumer's biometric information.

1. A method of securely transmitting digital text comprising:
a) utilizing a biometric sensor to generate a key for a customer;
b) utilizing said key to encrypt said digital text;
c) transmitting said encrypted digital text to said customer; and
d) utilizing said biometric sensor to decrypt said encrypted digital text.

2. The method of claim 1 wherein said digital text comprises movies in a studio film archive.

3. The method of claim 1 wherein said digital text comprises songs in a music archive.

4. The method of claim 1 wherein said digital text comprises financial information in a finance archive.

5. The method of claim 1 wherein said digital text comprises personal medical information.

6. The method of claim 1 wherein said digital text comprises master tapes generated in a recording studio.

7. The method of claim 1 wherein said digital text comprises government information.

8. The method of claim 1 wherein said key contains no biometric information.

9. The method of claim 1 wherein said encryption step is performed seven times.

10. The method of claim 1 wherein said encryption step comprises decryption limitations.

11. The method of claim 10 wherein said decryption limitations comprise expiration time periods.

12. The method of claim 10 wherein said decryption limitations comprise a numeric limit to the number of times the text may be decrypted.

13. The method of claim 1 wherein said transmission step is performed electronically.

14. The method of claim 1 wherein said transmission step is performed physically.

15. The method of claim 1 wherein transmission of said text to said customer does not contain said key.

16. A symmetric key system for securely transmitting digital text comprising:
a) digital text;
b) a customer;
c) a key unique to said customer;
d) a biometric sensor;
wherein said digital text is encrypted using said key prior to transmission,
wherein said encrypted digital text is transmitted without said key,
wherein said customer accesses said key using said biometric sensor,
wherein said customer decrypts said digital text utilizing said key.

17. The symmetric key system of claim 16 wherein said biometric sensor comprises a digital text reader, wherein said customer simultaneously accesses said key and decrypts said proprietary digital text using said biometric sensor/digital text reader.

18. The symmetric key system of claim 17 wherein said biometric sensor/digital text reader is portable.
